(19) United States
(12) Patent Application Publication
(10) Pub. No.: US 2004/0249964 A1
(43) Pub. Date: Dec. 9, 2004

(54) Method of data transfer and apparatus therefor

(76) Inventor: Thibault Mougel, West Lothian (GB)

Correspondence Address: PERMAN & GREEN, 425 POST ROAD, FAIRFIELD, CT, 06824, US

(21) Appl. No.: 10/382,547

(22) Filed: Mar. 6, 2003

(51) Int. Cl. G06F 15/16

(52) U.S. Cl. 709/231

(57) ABSTRACT

In the field of programmable devices, such as FPGAs, comprising multi-gigabit transceiver units, it is desirable to communicate a data stream of a first data rate between the programmable devices at a second data rate. In order to achieve this aim, the data stream is read from a first buffer at the second data rate by a first device and communicated to a second device at the second data rate. When the buffer empties, idle bits are inserted in the absence of data. Upon receipt by the second device, the idle bits are identified and removed prior to buffering.

### FIELD OF THE INVENTION

The present invention relates, in general, to a method of transferring a data stream of a first data rate over a data link at a second data rate. The present invention also relates, in general, to an apparatus for transferring a data stream of a first data rate over a data link at a second data rate.

### DESCRIPTION OF THE BACKGROUND ART

In the field of optical communications, an optical communications network is formed from a large number of different hardware and software components. Clearly, there is therefore a need for test equipment in order to measure the integrity of signals generated in the network. Such test equipment is able to transmit test signals comprising test frames representative of actual signals communicated in the network. The test equipment may also receive the test frames, and detect and record any errors.

Certain test equipment comprises a number of Field Programmable Gate Arrays (FPGAS) and/or Application Specific Integrated Circuits (ASICs) in order to complete certain high-speed computational tasks associated with the tests to be performed. For example, it is known for some test equipment to generate a so-called Bit-Error-Ratio Test (BERT) set, and/or error performance data. However, such tests are processing power intensive due to the amount of data that needs to be processed by a single FPGA at high speed.

Of recent, manufacturers of FPGAs have begun to design the FPGAs with multi-gigabit serial transceivers that support a communications protocol, such as a so-called XAUIs (pronounced “Zowies”; X Attachment Unit Interfaces; the “X” representing the Roman numeral for ten) protocol to enable communication of data between FPGAs at high speed, thereby allowing the computational burden to be shared between the FPGAs. The XAUI is a low pin count, self-clocked, serial bus protocol directly evolved from the Gigabit Ethernet (GbE). The XAUI protocol supports data rates 2.5 times that of GbE, and by supporting communications over four serial “lanes” a 10 GbE communications link is achieved.

As mentioned above, for certain tests, it is desirable to communicate data between FPGAs in order to share a computational process, and multi-gigabit serial transceivers provide a mechanism to achieve the desired data transfer via a relatively small number of differential tracks constituting a communications link coupling the transceivers. Also, at least one known test requires data received by the test equipment from a network under test to be sent back to the network under test. Therefore, another application exists for an FPGA, that is part of a receiver unit of the test equipment, to comprise a first multi-gigabit serial transceiver so as to permit communication of received data to another FPGA, that is part of a transmitter unit of the test equipment, the another FPGA comprising a second multi-gigabit serial transceiver.

The speed of the multi-gigabit serial transceivers permits the test equipment to process data borne using, for example, the American National Standards Institute (ANSI) Synchronous Optical NETwork (SONET) standard. Of course, data conforming to other standards, such as the Synchronous Digital Hierarchy (SDH) standard can also be processed. Indeed, in the case of a network analyser unit capable of testing both 10 GbE signals and SONET/SDH signals, the communications link between the FPGAs should be able to support the respective data rates associated with the signal types to be tested, for example 10 Gbps for the GbE packets, or 9.953280 Gbps for SONET OC-192 frames.

One known multi-gigabit serial communications specification for communicating data between FPGAs supports data communications at a rate of 10 Gbps. As mentioned above, one of the various data rates supported by the SONET standard is 9.953280 Gbps for OC-192 frames. A data rate mismatch therefore clearly exists if an inter-FPGA multi-gigabit serial communications link is used to communicate SONET OC-192 frames, which if not removed, will result in discrete-time jitter and data loss.

In order to facilitate the transfer of an incoming data stream, between FPGAs using the multi-gigabit serial transceivers, when the data rate of the incoming data stream and the data rate of the multi-gigabit serial transceivers are different, it is known to provide an apparatus which adapts a clocking frequency of the multi-gigabit serial transceivers to match the clock frequency of the incoming data stream. The frequency matching is performed, for example, by coupling FPGAs to external components such as a Phase Locked Loop (PLL) based clock generator, or a Voltage Controlled X Oscillator based clock generator, both of which are described in the XILINX Application Note entitled “SONET Rate Conversation in Virtex-II Pro Devices” (Application Note: Virtex-II Pro Family, XA pp649 (v1.1), May 14, 2002).

However, such known apparatus disadvantageously use external components, thereby increasing manufacturing overheads. Also, maintaining accuracy of clock synchronization is difficult and complex to achieve. Furthermore, once the apparatus is programmed to be adaptive to a specific incoming data stream dock frequency, the apparatus must be reprogrammed should a data stream of a different frequency be received.

According to a first aspect of the present invention, there is provided a method of communicating a data stream from a first communications unit of a first programmable logic device to a second communications unit of a second programmable logic device at a first data rate, the data stream comprising a plurality of data units and having a second data rate associated therewith, the method comprising the steps of: the first communications unit receiving the data stream; generating idle units and transmitting the idle units to the second communications unit when data is unavailable to be transmitted to the second communications unit; and wherein the first data rate is greater than or substantially equal to the second data rate.

In the context of communication of a data stream, an idle unit is a bit pattern indicative of an absence of bits constituting the communication of at least part of the data stream.

The method may further comprise the step of: temporarily storing the data constituting the data stream prior to transmission of the data stream to the second communications unit.

The method may further comprise the step of: generating and transmitting the idle units in response to a quantity of the temporarily stored data being equal to or less than a predetermined level.

The communication of the data steam from the first communications unit to the second communications unit may be in accordance with a predetermined communications protocol; the generation of the idle units may be in accordance with the protocol. A combination of types of idle units may be in accordance with the protocol.

The data may be temporarily stored in a first buffer; the buffer mat have a read-out rate corresponding to the first data rate.

The method may further comprise the step of: transmitting the data stream to the second communications unit at the first data rate.

The method may further comprise the step of: the second communications unit receiving the data stream from the first communications unit.

The method may further comprise the step of: removing the idle units from the received data stream.

The method may further comprise the step of: temporarily storing the received data stream after removal of the idle units therefrom.

The plurality of data units may be a plurality of packets.

The plurality of data units may be a plurality of frames.

The first device may be an ASIC or an FPGA.

The second device may be an ASIC or an FPGA.

Communication of the idle units between the first and second communications units may result in the idle units being interleaved with the data constituting the data stream.

According to a second aspect of the present invention, there is provided a programmable logic device for communicating at a first data rate a data stream comprising a plurality of data units and having a second data rate associated therewith, the device comprising: a communications unit arranged to receive, when in use, the data stream at the second data rate; wherein the communications unit is further arranged to generate idle units and transmit the idle units at the first data rate when data is unavailable for transmission to another programmable logic device at the first data rate; and the first data rate being greater than or substantially equal to the second data rate.

The communications unit may further comprise: a temporary store for storing the data constituting the data stream prior to transmission of the data stream.

The temporary store may be a first buffer, the first buffer may have a read-out rate corresponding to the first data rate.

The communications unit may further comprise: an idle unit insertion unit arranged to receive the data stream prior to transmission, and to generate the idle units when data is unavailable for transmission to another programmable logic device.

The idle units may be generated and transmitted in response to a quantity of the temporarily stored data being equal to or less than a predetermined level.

The idle unit insertion unit may be arranged to monitor the amount of data being stored by the temporary store.

The communication of the data steam from the first communications unit to the second communications unit may be in accordance with a predetermined communications protocol; the generation of the idle units may be in accordance with the protocol. A combination of types of idle units may be in accordance with the protocol.

The idle units may be generated so as to be interleaved with data constituting the data stream when the data constituting the data stream is transmitted by the communications unit.

According to a third aspect of the present invention, there is provided a programmable logic device for receiving at a first data rate a data stream comprising a plurality of data units and having a second data rate associated therewith, the device comprising: a communications unit arranged to receive, when in use, the data stream at the first data rate; wherein the communications unit is further arranged to remove idle units from the data stream for onward communication of the data stream at the second data rate; and the first data rate is greater than or substantially equal to the second data rate.

It should be appreciated that onward communication of the data stream embraces communication internal of a recipient programmable logic device and/or communication to an entity exterior to the recipient programmable logic device.

The communications device may comprise: an idle unit removal unit arranged to remove idle units from the data stream.

The communications unit may further comprise: a temporary store for receiving the received data stream after removal of the idle units therefrom.

The temporary store may be arranged so as to permit, when in use, data to be read-out of the temporary store at the second data rate.

The temporary store may be a buffer having a read-out rate associated therewith, the read-out rate corresponding, when in use, to the second data rate.

According to a fourth aspect of the present invention, there is provided a communications system for communicating at a first data rate a data stream comprising a plurality of data units and having a second data rate associated therewith, the system comprising: a first programmable logic device comprising a first communications unit capable of communicating the data stream to a second communications unit of a second programmable logic device at the first data rate; wherein the first communications unit comprises an idle unit insertion unit arranged to receive the data stream at the second data rate prior to transmission to the second communications unit, and generate, when in use, idle units when data is unavailable for transmission to the second communications unit; the second communications unit comprises an idle unit removal unit arranged to remove the idle units from the data stream for onward communication of the data stream at the second data rate; and the first data rate is greater than or substantially equal to the second data rate.

According to a fifth aspect of the present invention, there is provided a communications network analyser comprising the communications system as set forth above in relation to the fourth aspect of the present invention.

It is thus possible to provide an apparatus for transferring incoming data of a first data rate between programmable logic devices at different data rate, and a method of transferring incoming data of the first data rate between programmable logic devices at the different data rate. The complexity of the hardware constituting the apparatus is therefore simplified considerably, without the difficulties of clock synchronization. Additionally, the FPGAs do not require reprogramming in order to enable the data link between the programmable devices to communicate the incoming data when the data rate of the incoming data changes. It will be appreciated that the greater simplicity reduces the cost of manufacture of test equipment.

### BRIEF DESCRIPTION OF THE DRAWINGS

At least one embodiment of the present invention will now be described, by way of example only, with reference to the accompanying drawing, in which:

FIG. 1 is a schematic diagram of an apparatus constituting a first embodiment of the invention;

FIG. 2 is a schematic diagram of a communications link of FIG. 1 in greater detail; and

FIGS. 3 and 4 are flow diagrams of methods for use with the apparatus of FIG. 2.

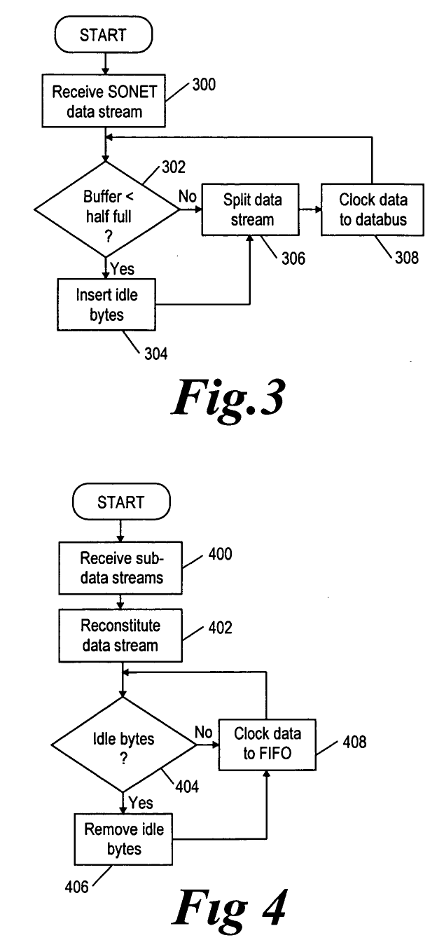

### DETAILED DESCRIPTION OF THE PREFERRED EMBODIMENTS

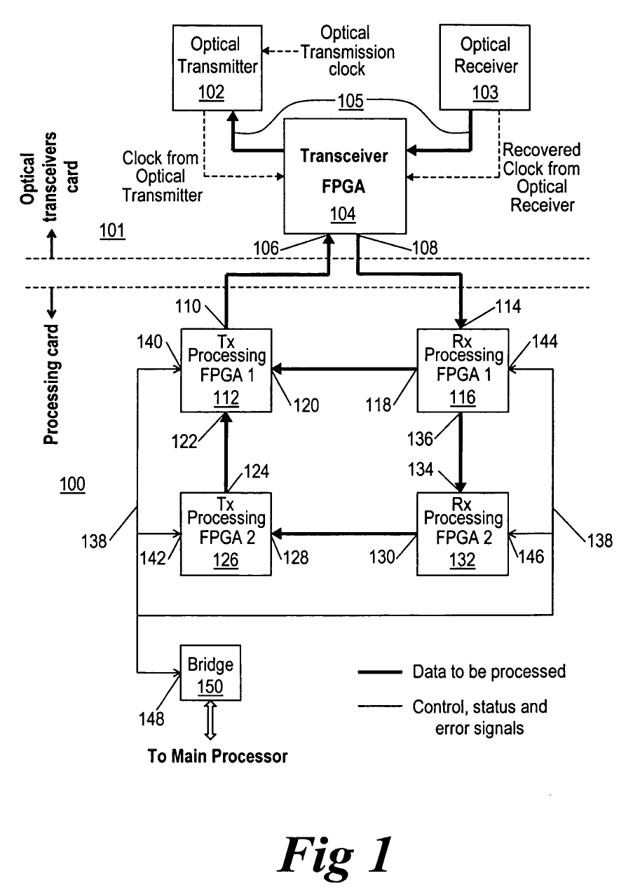

Referring to FIG. 1, a telecommunications network analyser, capable of testing 10 GbE packets and SONET frames, comprises a processing card 100 interfaced with an optical transceiver card 101. The optical transceiver card 101 comprises, inter alia, an optical transmitter module 102 comprising a transmitter port (not shown) and an optical receiver module 103 comprising a receiver port (not shown). The optical transmitter module 102 and the optical receiver module 103 are respectively coupled to a transceiver FPGA 104 by respective standard bus interfaces, such as of a SERDES (Serializer-Dezerializer) Framer Interfaced (SFI-4) type. The transceiver FPGA 104 has an input port 106 and an output port 108, the input port 106 of the transceiver FPGA 104 being coupled to an output port 110 of a first transmitter FPGA 112, and the output port 108 of the transceiver FPGA 104 being coupled to a first input port 114 of a first receiver FPGA 116. The input and output ports 106, 108 of the transceiver FPGA 104 are respectively coupled to the output port 110 and the first input port 114 by a multi-gigabit data link that is supported by the XAUI protocol.

A first output port 118 of the first receiver FPGA 116 is coupled to a first input port 120 of the first transmitter FPGA 112, a second input port 122 of the first transmitter FPGA 112 being coupled to an output port 124 of a second transmitter FPGA 126. A first input port 128 of the second transmitter FPGA 126 is coupled to an output port 130 of a second receiver FPGA 132, a first input port 134 of the second receiver FPGA 132 being coupled to a second output port 136 of the first receiver FPGA 116.

The inter-coupling of the first and second transmitter FPGAs 112, 126 and the first and second receiver FPGAs 116, 132 is by means of a further multi-gigabit data link that is supported by the XAUI protocol. A further data bus 138 for communicating control, status and/or error signals is coupled to a third input port 140 of the first transmitter FPGA 112, a second input port 142 of the second transmitter FPGA 126, a second input port 144 of the first receiver FPGA 116 and a second input port 146 of the second receiver FPGA 132. The further data bus 138 is also coupled to an input port 148 of a bridge FPGA 150, the bridge FPGA 150 being coupled to a main processing unit (not shown), the details of which need not be described in further detail for the purposes of describing this embodiment of the invention.

Although not shown, the processing card 100 comprises suitable circuitry, for example oscillator circuits, to generate a system clock signal and a transmission clock signal, the processing card 100 being appropriately configured to communicate the system and transmission clock signals to the FPGAs populating the processing card 100.

The above example will now be described, for the purposes of clarity of description and simplicity, in the context of a communications link between the first transmitter FPGA 112 and the first receiver FPGA 116. However, it should be appreciated that the principles of the following example is applicable to other communications links between devices incorporating transceivers, such as FPGAs and ASICs, and more particularly between the first and second transmitter FPGAs 112, 126 and the first and second receiver FPGAs 116, 132.

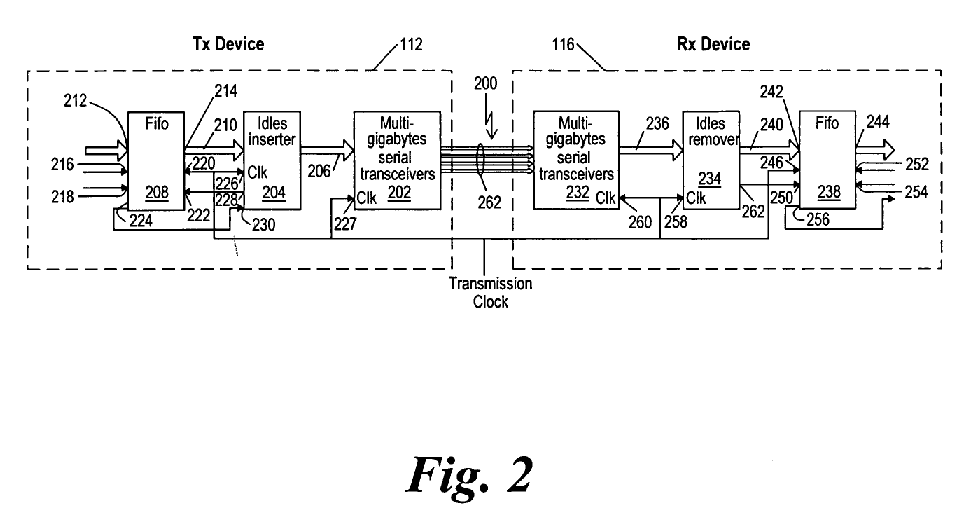

Referring to FIG.2, the first transmitter FPGA 112 supports a multi-gigabit data link 200 by comprising a first multi-gigabit serial transceiver unit 202. In this example, the first transmitter FPGA 112 is a Xilinx® Virtex II Pro FPGA comprising a Xilinx® Rocket I/O transceiver as the first transceiver unit 202. The first transceiver unit 202 is programmed to support the XAUI protocol.

The transceiver unit 202 is coupled to an idle byte insertion unit 204, via a first internal databus 206, the idle byte insertion unit 204 being coupled to a first First-In-First-Out (FIFO) buffer 208 via a second internal databus 210. The first FIFO buffer 208 comprises a first data-in port 212, a first data-out port 214 (coupled to the second internal databus 210), a first write-in clock port 216, a first write-enable clock port 218, a first read-out clock port 220, a first read-enable clock port 222 and a first FIFO status port 224. The read-out clock port 220 is coupled to a first serial transmission clock port 226 of the idle byte insertion unit 204, and a first transceiver clock port 227 of the transceiver unit 202; the first read-enable clock port 222 is coupled to a “Read Data” port 228 of the idle byte insertion unit 204. A “Data Request” port 230 of the idle byte insertion unit 204 is coupled to the first FIFO status port 224 of the first FIFO buffer 208.

The first receiver FPGA 116 also supports the data link 200 by comprising a second multi-gigabit serial transceiver unit 232. In this example, the first receiver FPGA 116 is also a Xilinx® Virtex II Pro FPGA also comprising a Xilinx® Rocket I/O transceiver as the second transceiver unit 232, the second transceiver unit 232 being programmed to support the XAUI protocol. The second transceiver unit 232 is coupled to an idle byte removal unit 234, via a third internal databus 236, the idle byte removal unit 234 being coupled to a second FIFO buffer 238 via a fourth internal databus 240. The second FIFO buffer 238 comprises a second data-in port 242, a second data-out port 244, a second write-in clock port 246, a second write-enable clock port 250, a second read-out clock port 252, a second read-enable clock port 254 and a second FIFO status port 256.

The second write-in clock port 246 is coupled to a second serial transmission clock port 258 of the idle byte removal unit 234 and a second transceiver clock port 260 of the second transceiver 232. The second write-in clock port 246, the second serial transmission clock port 258, the second transceiver clock port 260, the first transceiver clock port 227, the first serial transmission clock port 226 and the first read-out clock port 220 are coupled to a source of the transmission clock signal (not shown) already mentioned above in relation to FIG. 1. The second write-enable clock port 250 is coupled to a “Write Data” port 262 of the idle byte removal unit 234.

The first transceiver unit 202 is capable of communicating with the second transceiver unit 232 via the muti-gigabit data link 200. The first transceiver unit 202 and the second transceiver unit 232 are therefore both coupled to the data link 200 at opposite ends. The data link 200 comprises four data lanes 262 provided in accordance with the multi-gigabit serial communications specification being employed, in this example that supporting the Rocket I/O transceivers.

The above described apparatus will now be described in the context of communication between the first transmitter FPGA 112 and the first receiver FPGA 116. However, as previously stated, it should be appreciated that the following example is applicable to communications between other FPGAs comprising transceivers.

In operation, an incoming data stream (not shown) is received (step 300) by the first transmitter FPGA 112. In this example, the incoming data stream is a SONET OC-192 signal. The incoming data stream is communicated to the first FIFO buffer 208 via the first data-in port 212 and written into the first FIFO buffer 208 at a first data rate of the incoming data stream by applying the system clock signal to the first write-in clock port 216 and a first clock enable signal to the first write-enable port 218. Since the first transmitter FPGA 112 can process data at a far greater speed than the first data rate of the incoming datastream, the first clock enable signal is used to control the writing-in of data into the first FIFO buffer 208. The first clock enable signal is, in this example, generated separately by the first transmitter FPGA 112. For example, in the case of the SONET OC-192 signal, the first data rate at which the incoming data stream is written into the first FIFO buffer 208 is 9.953280 Gbps. Given that the system clock frequency is 84 MHz and the first transmitter FPGA 112 can process 128 bits per cycle of the system clock, the first clock enable signal is set to enable the system clock with respect to the first FIFO buffer 208 once every 1.08 clock cycles of the system clock.

In the first transmitter FPGA 112, the transmission clock signal is applied to the first read-out clock port 220 of the first FIFO buffer 208, first serial transmission clock port 226 of the idle byte insertion unit 204 and the transceiver clock port 227 in order to clock data from the first FIFO buffer 208 into the idle byte insertion unit 204 prior to communication to the first transceiver unit 202. The idle byte insertion unit 204 controls when data is read-out of the first FIFO buffer 208 by issuing a “read data” control signal at the read data port 228. The status of the read data control signal at the first read-enable port 222 of the first FIFO buffer 208 determines whether or not the transmission clock signal is enabled with respect to the first FIFO buffer 208 to allow data to be read-out of the first FIFO buffer 208. The transmission clock signal is predetermined and corresponds to a second data rate that is greater than or equal to, the maximum data rate of the incoming data stream, i.e. the first data rate. Consequently, in this example, the frequency of the transmission clock signal is 156.25 MHz to accommodate a 10 Gbps data throughput across the four lanes 262 of the data link 200.

Clearly, the first FIFO buffer 208 is therefore being emptied at a rate greater than the first FIFO buffer 208 is being filled. Consequently, data is only read-out of the first FIFO buffer 208 when the first FIFO buffer 208 is half-full. The status of the first FIFO buffer 208 is monitored (step 302) by the idle byte insertion unit 204 by monitoring the depth of the first FIFO buffer 208 via the first FIFO status port 224.

When the first FIFO buffer 208 is determined to be less than half-full by the idle byte insertion unit 204, the idle byte insertion unit 204 stops reading data out of the first FIFO buffer 208. Consequently, data to be communicated to the first transceiver unit 202 is absent, and so the idle byte insertion unit 204 replaces (step 304) the absence of data with one or more predetermined idle byte. In this example, the idle bytes can be a random distribution of the different types of idle bytes in accordance with rules specified for the use of idle bytes by the XAUI protocol. For example, under the XAUI protocol three different types of idle bytes having different functions are specified and are termed types R, A and K.

In this example, the data is being transmitted between the first and second transceivers 202, 232 in packets, prior to the interleaving of the idle bytes. Each packet of data is preceded by a “Start” octet and followed by a “Terminate” octet. The idle byte insertion unit 204 ensures that the idle bytes being interleaved are distributed in such a manner that the distribution of idle bytes conforms to the specification for multi-gigabit communications using the first and second transceivers 202, 232. Once idle bytes have been interleaved, a number of the start and terminate octets are separated by a group of bytes constituting at least one valid idle sequence as defined by the XAUI protocol.

The data stream, as adapted by the idle byte insertion unit 204, is divided (step 306) into four separate sub-bit streams for respective communication via the four lanes 262 in accordance with the multi-gigabit communication specification, the divided data being transmitted (step 308) to the second transceiver unit 232. At the second transceiver unit 232, the sub-bit streams are received (step 400) at the second data rate corresponding to the transmission clock frequency and reconstituted (step 402) to a single bit stream that was the incoming bit stream to the first transceiver 202. The reconstituted bit stream is then communicated to the idle byte removal unit 234 of the first receiver FPGA 116 at the transmission clock frequency. The idle bytes interleaved amongst the packets of data of the reconstituted data stream are then identified (step 404) by the idle byte removal unit 234 and removed (step 406), when present, from the reconstituted stream prior to communication (step 408) of the processed data stream to the second FIFO buffer 238 at the transmission dock frequency. In this example, the idle bytes are removed by simply not providing a write-enable signal at the write data port 262, thereby preventing the idle bytes from being clocked into the second FIFO buffer 238.

The data stream is clocked out of the idle byte removal unit 234 at the transmission clock frequency, which corresponds to a higher data rate than that of the originating SONET signal. Consequently, the data written into the second FIFO buffer 218 is then readout of the second FIFO buffer 218 at the clock frequency of the SONET signal, by the combined use of the system clock signal and a second read-enable signal applied to the second read-out clock port 252 and the second read-enable port 254 respectively, thereby reconstituting the SONET signal. The SONET signal is then processed further by the first receiver FPGA 116. In this example, the second read-enable signal is generated separately by the first receiver FPGA 116.

The above described technique for communicating SONET data streams between FPGAs is employed, in the embodiment described in relation to FIG. 2, in order to transmit a SONET data stream received from a network under test back to the network under test, with or without alterations as necessary for the particular test being carried out by the test equipment.

Alternatively, the same communications technique can be employed to communicate SONET data streams between the first transmitter FPGA 112 and the second transmitter FPGA 126 in order to reduce the processing burden on the first transmitter FPGA 112 when checking Transport Overhead (TOH) and payload data for errors during a test. In such an example, the payload data can be transmitted from the first transmitter FPGA 112 to the second transmitter FPGA 126 for analysing the payload data for errors and, for example, reporting the status of certain bits in the payload, whilst the first transmitter FPGA 112 analyses the TOH data for errors and, for example, reporting the status of certain bits In the TOH data.

Status information and any errors found in the TOH data by the first transmitter FPGA 112 are communicated to the bridge FPGA 150 via the further databus 138, and status Information and any errors in the payload found by the second transmitter FPGA 126 are also communicated to the bridge FPGA 150 via the further databus 138. Errors and status information communicated to the bridge FPGA 150 are then communicated to the main processing unit (not shown) for appropriate action in accordance with the test procedure.

Whilst the above examples have been described in the context of a SONET signal, it should be appreciated that, with suitable modifications, the above examples can be used to communicate other digital signals of data rates equal to or less than that of a data rate used to communicate data between transceivers of the programmable logic devices. Indeed, the present invention is applicable to any programmable logic device supporting a multi-gigabit serial transceiver, for example programmable integrated circuits, comprising a transmitter unit and/or a receiver unit, or a transceiver unit, and where there is a need to communicate a received data stream of a first data rate between the programmable devices at a second data rate.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device.

What is claimed is:

1. A method of communicating a data stream from a first communications unit of a first programmable logic device to a second communications unit of a second programmable logic device at a first data rate, the data stream comprising a plurality of data units and having a second data rate associated therewith, the method comprising the steps of:
the first communications unit receiving the data stream;
generating idle units and transmitting the idle units to the second communications unit when data is unavailable to be transmitted to the second communications unit; and wherein
the first data rate is greater than or substantially equal to the second data rate.

2. The method according to claim 1, further comprises the step of:
temporarily storing the data constituting the data stream prior to transmission of the data stream to the second communications unit.

3. The method according to claim 2, further comprising the step of:
generating and transmitting the idle units in response to a quantity of the temporarily stored data being equal to or less than a predetermined level.

4. The method according to claim 1, wherein the communication of the data steam from the first communications unit to the second communications unit is in accordance with a predetermined communications protocol, the generation of the idle units being in accordance with the protocol.

5. The method according to claim 4, wherein a combination of types of idle units is in accordance with the protocol.

6. The method as claimed in claim 2, wherein the data is temporarily stored in a first buffer, the buffer having a read-out rate corresponding to the first data rate.

7. The method according to claim 1, further comprising the step of:
transmitting the data stream to the second communications unit at the first data rate.

8. The method according to claim 1, further comprising the step of:
the second communications unit receiving the data stream from the first communications unit.

9. The method according to claim 8, further comprising the step of:
removing the idle units from the received data stream.

10. The method as claimed in claim 9, further comprising the step of:
temporarily storing the received data stream after removal of the idle units therefrom.

11. The method according to claim 1, wherein the plurality of data units is a plurality of packets.

12. The method according to claim 1, wherein the plurality of data units is a plurality of frames.

13. The method according to claim 1, wherein the first device is an ASIC or an FPGA.

14. The method according to claim 1, wherein the second device is an ASIC or an FPGA.

15. The method according to claim 1, wherein communication of the idle units between the first and second communications units results in the idle units being interleaved with the data constituting the data stream.

16. A programmable logic device for communicating at a first data rate a data stream comprising a plurality of data units and having a second data rate associated therewith, the device comprising:
a communications unit arranged to receive, when in use, the data stream at the second data rate; wherein
the communications unit is further arranged to generate idle units and transmit the idle units at the first data rate when data is unavailable for transmission to another programmable logic device at the first data rate; and
the first data rate being greater than or substantially equal to the second data rate.

17. The device according to claim 16, wherein the communications unit further comprises:
a temporary store for storing the data constituting the data stream prior to transmission of the data stream.

18. The device as according to claim 17, wherein the temporary store is a first buffer, the first buffer having a read-out rate corresponding to the first data rate.

19. The device according to claim 17, wherein the communications unit further comprises:
an idle unit insertion unit arranged to receive the data stream prior to transmission, and to generate the idle units when data is unavailable for transmission to another programmable logic device.

20. The device according to claim 17, wherein the idle units are generated and transmitted in response to a quantity of the temporarily stored data being equal to or less than a predetermined level.

21. The device according to claim 19, wherein the idle unit insertion unit is arranged to monitor the amount of data being stored by the temporary store.

22. The device according to claim 16, wherein the communication of the data steam from the first communications unit to the second communications unit is in accordance with a predetermined communications protocol, the generation of the idle units being in accordance with the protocol.

23. The device according to claim 22, wherein a combination of types of idle units is in accordance with the protocol.

24. The device according to claim 16, wherein the idle units are generated so as to be interleaved with data constituting the data stream when the data constituting the data stream is transmitted by the communications unit.

25. A programmable logic device for receiving at a first data rate a data stream comprising a plurality of data units and having a second data rate associated therewith, the device comprising:
a communications unit arranged to receive, when in use, the data stream at the first data rate; wherein
the communications unit is further arranged to remove idle units from the data stream for onward communication of the data stream at the second data rate; and
the first data rate is greater than or substantially equal to the second data rate.

26. The device according to claim 25, wherein the communications device comprises:
an idle unit removal unit arranged to remove idle units from the data stream.

27. The device according to claim 25, wherein the communications unit further comprises:
a temporary store for receiving the received data stream after removal of the idle units therefrom.

28. The device according to claim 27, wherein the temporary store is arranged so as to permit, when in use, data to be read-out of the temporary store at the second data rate.

29. The device according to claim 28, wherein the temporary store is a buffer having a read-out rate associated therewith, the read-out rate corresponding, when in use, to the second data rate.

30. A communications system for communicating at a first data rate a data stream comprising a plurality of data units and having a second data rate associated therewith, the system comprising:
a first programmable logic device comprising a first communications unit capable of communicating the data stream to a second communications unit of a second programmable logic device at the first data rate; wherein
the first communications unit comprises an idle unit insertion unit arranged to receive the data stream at the second data rate prior to transmission to the second communications unit, and generate, when in use, idle units when data is unavailable for transmission to the second communications unit;
the second communications unit comprises an idle unit removal unit arranged to remove the idle units from the data stream for onward communication of the data stream at the second data rate; and
the first data rate is greater than or substantially equal to the second data rate.

31. A communications network analyser comprising the communications system according to claim 29.
